(19) United States
(12) Patent Application Publication
(10) Pub. No.: US 2024/0102814 A1
(43) Pub. Date: Mar. 28, 2024

(54) DETERMINING SAFETY LEVEL SCORES FOR TRAVEL PARKING SPOTS

(71) Applicant: INTERNATIONAL BUSINESS MACHINES CORPORATION, Armonk, NY (US)

(72) Inventors: Venkata Vara Prasad Karri, Visakhapatnam (IN); Hemant Kumar Sivaswamy, Pune (IN); Partho Ghosh, Kolkata (IN); Saraswathi Sailaja Perumalla, Visakhapatnam (IN)

(21) Appl. No.: 17/952,582

(22) Filed: Sep. 26, 2022

(51) Int. Cl. G01C 21/34; G01C 21/36

(52) U.S. Cl. CPC G01C 21/3461; G01C 21/3685

(57) ABSTRACT

Generating safety level scores of travel parking spots by an AI model trained by supervised learning using labeled online source data and static and dynamic IoT data, determining a current location and travel route of a vehicle, identifying potential travel parking spots within the geospatial area of the current location and travel route of the vehicle, receiving data from online sources and static and dynamic data of IoT devices in the vicinity of the travel parking spots, generating by the AI model, safety level scores for the travel parking spots within a geospatial area of the vehicle, and sending a listing of the safety level scores to a computing device associated with the vehicle.

### FIELD OF THE INVENTION

The disclosure relates generally to the determination of safe conditions for rest area vehicle parking. The invention relates particularly to determining a safety confidence level for a vehicle and passengers associated with a rest area vehicle parking location.

### BACKGROUND

Users traveling longer distances by vehicle often segment their travels with rest breaks in which the vehicle parks for a period of time before continuing travel. In some cases, the rest break from travel may be relatively brief, whereas in other cases the rest break may include sleep or overnight parking of the user within the vehicle.

Digital maps and online applications are helpful for users making travel plans, however, location information of rest area parking for vehicle travel, as well as details about the particular parking location are readily available. Users traveling longer distances by vehicle may elect to use a rest area parking location due to fatigue, clarifying travel routes, inclement weather, or other issues that can be resolved or improved by pausing travel. Users may opt to continue traveling under non-optimal conditions rather than park due to a lack of information regarding a rest area parking spot.

### SUMMARY

The following presents a summary to provide a basic understanding of one or more embodiments of the disclosure. The purpose of this summary is to introduce concepts in a simplified form that are presented and more thoroughly described in the detailed description of this document. The summary is not intended to limit the scope of the embodiments included, herein, or any scope of the claims, or to identify key or critical elements. In one or more embodiments described herein, devices, systems, computer-implemented methods, apparatuses, and/or computer program products enable the determination of a level of safety score of a vehicle parking spot.

Aspects of the invention disclose methods, systems and computer readable media associated with determining a level of safety of a location of travel rest area parking of a vehicle in which methods receive a request for safety level information for travel parking spots within a geospatial area, determine a current location and a travel route of a vehicle, identify potential travel parking spots within the geospatial area of the current location and travel route of the vehicle, receive data from online information sources and static and dynamic IoT devices in a vicinity of the travel parking spots within the geospatial area and travel route of the vehicle, generate a safety level score for travel parking spots in the geospatial area of the current location, based on an AI model trained by IoT device data, and online data sources associated with travel parking area safety levels, and applying weighting to a type and a source of the IoT data and the online data, and send to a computing device associated with the vehicle, a listing of travel parking spots with a safety level score exceeding a threshold value of safety level and locations of the travel parking spots, respectively, within the geospatial area of the current location and travel route of the vehicle.

### BRIEF DESCRIPTION OF THE DRAWINGS

Through the more detailed description of some embodiments of the present disclosure in the accompanying drawings, the above and other objects, features, and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, however, embodiments of the present disclosure can be implemented in various manners, and thus should not be construed to be limited to the embodiments disclosed herein.

Embodiments of the present invention recognize that users traveling longer distances by vehicle may wish to pause their travel for rest, navigation clarification, weather conditions, or other reasons. Embodiments recognize that users may question the level of safety associated with parking at a vehicle travel rest area and the risks associated with a lack of information about particular rest area parking spots. Vehicle rest area parking locations, also referred to, herein, as “travel parking spots,” may have a history of crime, theft, injury, hazards, or known wildlife encounter risks or, alternatively, may have IoT and crowd-sourced monitoring, frequent patrols by law enforcement, and social media feedback by recent and current visitors indicating a relatively high level of safety. Embodiments recognize that a lack of information and determination of the safety level of a rest area parking spot results in random selection by traveling users, which may have consequences for the traveling users, or may motivate traveling users to decline from using rest area parking spots, increasing risks of fatigue, weather-based accidents, or navigation errors.

Aspects of the present invention relate generally to determining safety levels associated with travel parking spots for vehicles on travel routes within a geospatial area. Disclosed embodiments include methods that receive data associated with travel parking spots within the geospatial area from IoT devices in the vicinity of respective parking spots, and online data sources. Methods identify a current location of a vehicle and the vehicle's travel route and determine potential travel parking spots from online mapping sources and online information from travel information and social media sites. Methods apply received data associated with travel parking spots to geospatial spot security (GSS) service that includes an artificial intelligence (AI) model trained to generate a safety level score for travel parking spots. The GSS model determines a safety level score for the identified travel parking spots in the geospatial area of the current location of the vehicle. Methods send a listing of travel parking spots with safety level scores exceeding a threshold value to a computing device associated with the vehicle.

An aspect of embodiments of the present invention includes an improvement to travel guidance applications, navigation technology, and information guiding actions to improve travel parking spot safety. Embodiments provide vehicle travelers with safety scores of travel parking spots, eliminating random selection and reducing risks to vehicles and passengers while parking. Risks to passengers may include assault, theft, and other offenses by people, and in some environments, injury from conditions and wildlife in the vicinity of a travel parking spot may present a potential harm to passengers that have exited their vehicle. Risks to vehicles may include vandalism, vehicle-to-vehicle collision, and damage from environmental conditions of the travel parking spot (i.e., dead trees, falling rocks, etc.). Embodiments of the present invention that are integrated with navigation technology can provide continuous travel parking spot safety scores and locations during user travel. Embodiments resulting in safety level scores below a threshold can be further directed to administrative or overseeing organizations to initiate actions to increase safety level scores of identified low safety level scoring travel parking spots.

Another aspect of embodiments of the present invention includes the use of feedback and recommendation data from known users as input to a GSS model in generating safety level scores. Embodiments further weight the feedback and recommendations by determining the closeness of contacts within social media applications to the user of the vehicle, with user consent. For example, a vehicle user's direct friend contact receives greater weight than a friend of the friend of the vehicle user. Embodiments may also provide greater weight to the feedback input data by consideration of the gender of the known users, such that the feedback of a parking spot being safe provided by a female user receives greater weight than safe feedback received from a male user.

Another aspect of embodiments includes accessing public safety organizations that include historical records of incidents and documented risk situations at travel parking spots. Embodiments receive data by accessing organizations such as law enforcement, government agencies (i.e., transportation, public works), and environmental management (i.e., environmental officers, wildlife management), and input the data to the GSS model and receive higher weighting in determining safety level scores of travel parking spots. In some embodiments, the formation of an ad-hoc safety level group includes receiving feedback and recommendations of trusted user in a blockchain data structure. A pre-determined threshold number of current trusted users in the blockchain data structure provides a level of trust confidence of additional users to be added to the blockchain structure. Initial blockchain members of trusted users may be from the vehicle user's contact profile information, with consent.

In accordance with aspects of the invention, methods receive a request for safety-level information of travel parking spots within a geospatial area. In some embodiments, a user of a device associated with a vehicle on a travel route within a geospatial area initiates the request. In other embodiments, a pre-determined duration of travel time of the vehicle automatically provides initiation of the request.

Methods determine the current location and travel route of a vehicle. In some embodiments, the location and travel route of the vehicle is determined by GPS data in combination with a mapping or navigation application. Current location and travel route provide a basis to determine potential travel parking spots for consideration, which may be determined based on historic information, mapping applications, travel services, and social media sources. In some embodiments, identified potential travel parking spots are selected based on being located within the determined geospatial area of the vehicle and travel route.

Methods receive data from online information sources and static and dynamic IoT devices in the vicinity of the travel parking spots within the geospatial area and travel route of the vehicle. In some embodiments, static and dynamic IoT devices provide video and photo images of a travel parking spot. Static IoT devices may include IoT cameras, infrared cameras, microphones, and motion detectors positioned at or in a vicinity of a respective travel parking spot. Dynamic IoT devices include sensors of vehicles temporarily positioned at, near, or in the vicinity of the respective travel parking spot. The dynamic IoT devices may include front and rear dashcams, proximity sensors, other sensor feeds, and GPS functionality, which may be received from consenting vehicle owners.

In some embodiments, data is received (e.g., based on requests from, or access by the GSS service) from online sources, which may include historical information regarding reported incidents at a respective travel parking spot, trusted feedback, news sources, online notifications from agencies overseeing travel rest spots. Embodiments may include receipt of data from trusted feedback on social media, which may be designated as “trusted” by consented use of contact information in a user's profile, and corroboration of unknown user feedback by known users and friends, for example. Embodiments may include receipt of notifications from advisory sources, such as law enforcement, government agencies, wildlife management, and community service bulletin boards, for example. An aspect of the invention includes receipt of feedback data from a formation of crowd-sourced information initiated from the first level of a vehicle users' friends and known people, and the first level has their group of friends and known people for a second level, and the second level has their group of friends and known people, and so on.

Methods generate a safety level score for travel parking spots in the geospatial area of the current location, based on an artificial intelligence (AI) GSS model trained by IoT device data, and online data sources associated with travel parking area safety levels, and applying weighting to a type and a source of the IoT data and the online data. Embodiments apply supervised learning and use labeled historical data from static and dynamic IoT devices and online public notification sources, as well as exemplary social media feedback, as input to train the GSS model. Weighted input includes greater weight given to an amount of static and dynamic IoT data of a travel parking spot, feedback, and recommendation by known users, gender of known users, government agency advisory and notifications, and currency of the data. Weighted input also includes personal friends designating a spot safe, which would be weighted higher, friends of friends or unknown feedback would be weighted lower, but weights may be given higher ratings with increases in the volume of consensus safety level. The training data includes various levels of risk and threats and includes the addition of weighting to confirmed historical data, designated known users and friends, additional weight based on the gender of known users, and may include wildlife scenarios that present safe and unsafe levels of risk.

Methods send a listing of travel parking spots with a safety level score exceeding a threshold value of safety level and locations of the travel parking spots, respectively, within the geospatial area of the current location and travel route of the vehicle to a computing device associated with the vehicle. In some embodiments, methods provide a recommendation based on the safety level scores of the listing of travel parking spots. In some embodiments, the threshold value of safe travel parking spots is determined based on the location and geospatial area of the vehicle and travel route. An aspect of the invention includes activating a vehicle alarm signal upon detection of an anomaly of safe level conditions during periods of vehicle parking within the travel parking spot.

An aspect of the disclosed invention includes receiving real-time data from static and dynamic IoT data sources and integrating the IoT data (i.e., video, photo, IR, motion detection sensor feeds) with the traveling vehicle sensor system (i.e., front and rear dashcams, IR sensors, touch sensors, GPS), and saving IoT and sensor data to storage and using the data for continual training and refinement of the GSS AI model. Another aspect of the disclosed invention utilizes a pre-determined range between a travel parking spot and the vehicle to initiate a visualization of parking area in a display feature of the vehicle or user device. The integration of the IoT device data feed with the vehicle safety and sensor system provides data to generate and display a field of view dashboard displaying the visualization on a device associated with the vehicle (e.g., the user's device and/or vehicle display device). Aspects of the disclosed invention also include an automatic tagging feature of a travel parking spot location based on a trusted member of an ad-hoc group that parks at the travel parking spot location for at least a pre-determined time threshold. The automatic tagging feature includes the travel parking spot location along with the date, time, and consented trusted member's profile information.

An aspect of the invention includes triggering the connected vehicle alarm or IoT alarm that may be associated with the travel parking spot by detection of a potential anomaly of a safe level of the travel parking spot based on the safe level threshold. The triggering of a threshold-based anomaly alarm may also provide notification to the vehicle's or vehicle user's device.

Another aspect of the disclosed invention includes the formation of ad-hoc trusted groups participating in online social media providing explicit feedback, in which the group trust level leverages social media contact lists of known users or direct friends to establish a level of trust/confidence. With consent, detection of vehicles parking at a spot for a pre-determined time automatically adds the users of the vehicles to the GSS system application. Embodiments share, with consent, the automatic tagging of parking spots with date, time, and user's profile information to friends and/or trusted known users when the friends and/or trusted known users travel the same route. In some embodiments, users of an ad-hoc trusted group may be automatically added to a blockchain structure that generates a request of the vehicle user to provide feedback regarding the safety of the travel parking spot during the stay. Embodiments add users to the blockchain structure based on identification of the vehicle and the location of the travel parking spot by GPS data, and the vehicle exceeding a triggering duration of parking at the travel parking spot. In some embodiments, the GSS model receives user feedback on the experience of using travel parking spots and incorporates the feedback to improve the model.

The solution and improvements provided by the method are not abstract and cannot be performed as a set of mental acts by a human due to the reliance on IoT device data, online source data, and determination of the location of a traveling vehicle as well as the travel parking spots within the geospatial area of the vehicle, for example. Further, the receipt, weighting, and compilation of both dynamic and static sources of input data cannot be reasonably received and processed by the mental act of a human.

In an embodiment, one or more components of the system can employ hardware and/or software to solve problems that are highly technical in nature (e.g., applying a plurality of methods to a data set to determine travel parking spots within the geospatial area of the vehicle and travel route, generate safety level scores, applying generated scores to identified travel parking spots, and sending a listing of travel parking spots to a device associated with the vehicle, which could be a display device of the vehicle user or a display device integrated with the vehicle). These solutions are not abstract and cannot be performed as a set of mental acts by a human due to the nature and source of data required as input to train the GSS model and processing to perform the generation of safety level scores for identified travel parking spots, for example.

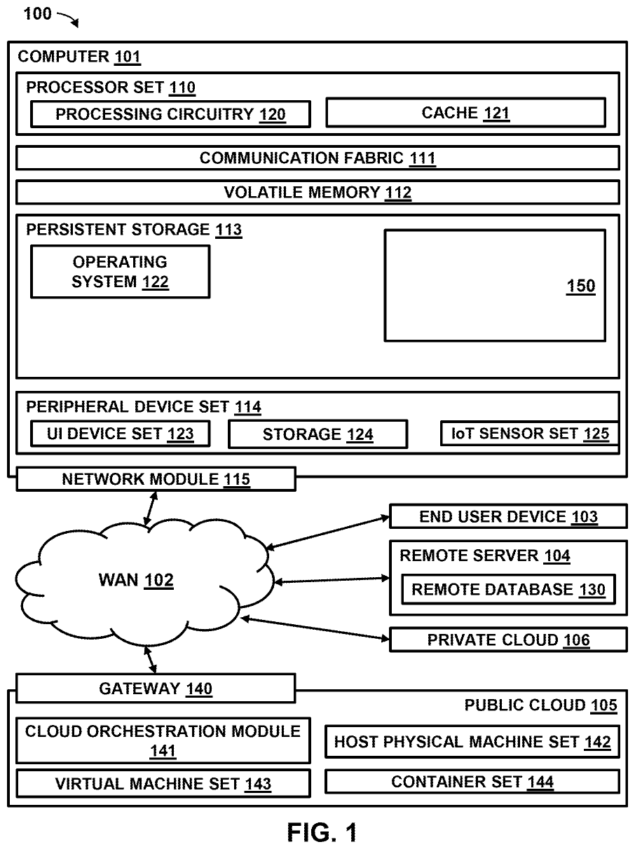

As shown in FIG. 1, computing environment 100 contains an example of an environment for the execution of at least some of the computer code involved in performing the inventive methods, such as the methods of programming generating safety level scores in block 150 (, retained in persistent storage 113. In addition to block 150, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including an operating system 122 and a safety level scores program of block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or another wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation on computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored as a safety level scores program in block 150, in persistent storage 113.

COMMUNICATION FABRIC 111 includes the signal conduction paths that allow the various components of computer 101 to communicate with each other. Typically, this fabric includes switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things (IoT) applications. For example, one sensor may be a thermometer and another sensor may be a motion detector. In an exemplary embodiment, IoT sensor set 125 includes static and dynamic IoT devices providing input data to the GSS model along with historical and online social media-based data.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers. In an exemplary embodiment, WAN 102 enables access to and receipt of data from historical data of safety-related incidents of travel parking spots, which may be stored in a remote database 130. WAN 102 also enables access to and receipt of data from social media sources, blockchain data, and ad-hoc crowd-sourced feedback data, which may be accessed via gateway 140 to public cloud 105, for example.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on. In some embodiments, EUD 103 receives and displays a listing of safety level scores for travel parking spots in the geospatial area of the user's vehicle and one or more recommendations.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

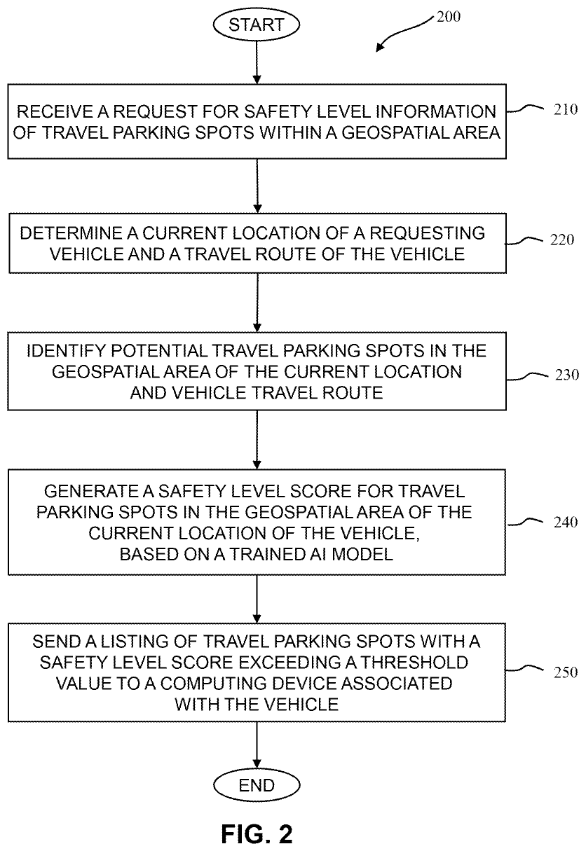

FIG. 2 provides a flowchart 200, illustrating exemplary activities associated with the practice of the disclosure. Subsequent to program initiation, at block 210, methods receive a request for safety-level information of travel parking spots within a geospatial area. In some embodiments, the request for safety level information is initiated from an application (app) operating on a computing device of a user of a vehicle on a travel route within a particular geospatial area. In other embodiments, the request for safety level information of travel parking spots initiates automatically subsequent to a pre-defined time of vehicle travel.

At block 220, methods determine a current location of a vehicle requesting travel parking safety information and a travel route of the vehicle. The current location is determined from global positioning system (GPS) data received from the vehicle or devices within the vehicle. The GPS data in combination with accessing a road map or a navigation app is used to determine the travel route of the vehicle. The current location and travel route determination are used to define a geospatial area, which is pre-determined and configurable based on the density of travel parking spots.

At block 230, methods identify potential travel parking spots within the geospatial area of the determined current location and travel route. In an embodiment, mapping and navigation applications, online travel guides, social media sources, and historical records are searched to identify and locate travel parking spots within the geospatial area. The potential travel parking spots receive an identity from which historical, current, and future data on their respective safety level is applied. In an embodiment, methods identify the travel parking spots within the geospatial area to access and receive data corresponding to the respective identified travel parking spots. Methods applied to determine factors contributing to safety level scores may include time series and hot spot analysis, linear regression, elastio-net, Support Vector Machines (SVMs) with radial and linear kernels, decision tree, bagged CART, random forest, and stochastic gradient boosting, alone, in combination, or combined with machine learning methods.

At block 240, methods generate a safety level score for travel parking spots in the geospatial area of the current location. In an embodiment, an AI model (geospatial spot security-GSS) is trained by applying IoT device data, and online data sources associated with travel parking area safety levels and applying weighting to a type and a source of the IoT data and the online data. The GSS model is trained by applying supervised learning labeling the IoT device data and online data and using certified historical data from IoT static and dynamic devices, and online public notification sources, as well as exemplary social media feedback as input. The training data includes various levels of risk and threats and includes the addition of weighting to confirmed historical data, designated known users and friends, additional weight based on the gender of known users, and may include wildlife scenarios that present safe and unsafe levels of risk. In some embodiments, the IoT data includes static feeds from a vicinity of a travel parking spot as well as dynamic feeds of dashcam images and other sensor feeds, which may be received from consenting vehicle owners whose vehicles reside in a vicinity of a respective travel parking spot.

Methods generate a safety level score for each of the travel parking spots within the geospatial area and organize a listing of the parking spots in an order, for example, from the highest (most safe) safety level score to the lowest safety level score. In some embodiments, methods include a distance to respective travel parking spots and may include a time estimate to reach the travel parking spot based on vehicle average velocity and known speed limits of the travel route. Methods may determine a relative score of safety level, such as “very safe”, “safe”, “moderately safe”, “unsafe”, or “very unsafe.” Alternatively, methods may generate a numerical score such as “82% safe” or a “safety level of 75.” Methods determine a safety level based on aggregating input data and weighting the data based on features of the travel parking spot, data type from historical records, the currency of data, and the quantity of contributing features and data. Features, for example, may include the proximity of other populated buildings, surveillance devices, law enforcement patrols, remoteness of the parking location, previously reported crime instances, and the type of crime reported.

At block 250, methods send a listing of travel parking spots with a safety level score exceeding a threshold value. Methods send a listing of travel parking spots to a computing device associated with the vehicle based on the safety level scores of travel parking spots exceeding a threshold level, which are set to a default level based on historic information associated with a travel parking spot and enable it to be configurable. The computing device may be an end-user device, such as EUD 103 of FIG. 1, or the computing device may be integrated with the vehicle and enabled to display the listing of travel parking spots, respective location, and distance to reach, and generated safety level score, for example. In some embodiments, methods provide a recommendation of a travel parking spot based on safety level scores.

In an embodiment, the geospatial area changes, incrementally or continuously, as the vehicle progresses along a travel route. Aspects of the disclosed invention include methods generating a field of view dashboard (i.e., on a display) providing a visualization of a travel parking spot from available and connected IoT devices in the vicinity of the parking spot.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

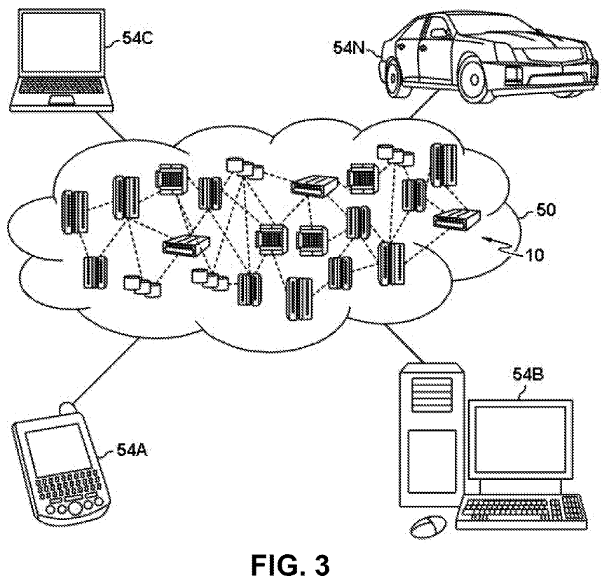

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

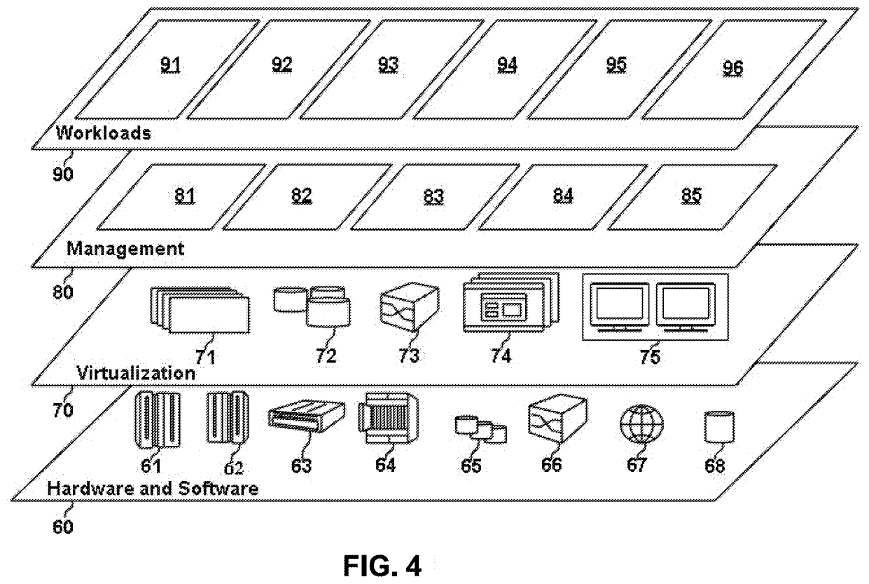

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and training data set selection program 175.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for determining a level of safety of a location for travel rest area parking of a vehicle, the method comprising:
determining, by one or more processors, a current location and a travel route of a vehicle;
identifying, by the one or more processors, potential travel parking spots within a geospatial area of the current location and the travel route of the vehicle;
receiving, by the one or more processors, data from online information sources and static and dynamic Internet of Things (IoT) devices in a vicinity of the travel parking spots within the geospatial area and the travel route of the vehicle;
generating, by the one or more processors, a safety level score for the travel parking spots in the geospatial area of the current location, based on an artificial intelligence (AI) model trained by IoT device data, and online data sources associated with travel parking area safety levels, and applying weighting to a type and a source of the IoT data and the online data; and
sending, by the one or more processors, a listing of the travel parking spots with the safety level score exceeding a threshold value of safety level and locations of the travel parking spots, respectively, within the geospatial area of the current location and the travel route of the vehicle.

2. The computer implemented method according to claim 1, wherein the online information sources include historical incident reports, government agency notifications, social media applications.

3. The computer implemented method according to claim 1, wherein social media input includes formation of ad-hoc groups providing input of safety level experience at the travel parking spots from friends of and users known by the vehicle user.

4. The computer implemented method according to claim 1, wherein the IoT device data includes static and dynamic data, integrated with a vehicle sensor system and sensor data.

5. The computer implemented method according to claim 1, further comprising:
generating, by the one or more processors, a field of view dashboard providing a visualization of a particular travel parking spot of the listing of the travel parking spots, based on sensor feeds of the static and dynamic IoT devices in a vicinity of the particular travel parking spot.

6. The computer implemented method according to claim 1, further comprising:
detecting, by the one or more processors, the vehicle parking in a particular travel parking spot;
tagging automatically, by the one or more processors, the particular travel parking spot with a date, time, and profile information of a vehicle user; and
adding, by the one or more processors, information included in tagging of the particular travel parking spot in a blockchain data structure accessible online to trusted members of an ad-hoc group, wherein the vehicle user is determined to be trusted by a threshold of current ad-hoc group members.

7. The computer implemented method according to claim 1, wherein data input to the geospatial spot security (GSS) model is weighted, such that feedback data of safety levels of travel parking spots are more heavily weighted for known users and friends of a user of the vehicle, and female gender friends and the known users are weighted more than male friends and the known users.

8. A computer program product for determining a level of safety of a location for travel rest area parking of a vehicle, the computer program product comprising:
at least one computer readable storage medium and program instructions collectively stored on the at least one computer readable storage medium, the stored program instructions comprising:
program instructions to determine a current location and a travel route of a vehicle;
program instructions to identify potential travel parking spots within a geospatial area of the current location and the travel route of the vehicle;
program instructions to receive data from online information sources and static and dynamic Internet of Things (IoT) devices in a vicinity of the travel parking spots within the geospatial area and the travel route of the vehicle;
program instructions to generate a safety level score for the travel parking spots in the geospatial area of the current location, based on an artificial intelligence (AI) model trained by IoT device data, and online data sources associated with travel parking area safety levels, and applying weighting to a type and a source of the IoT data and the online data; and
program instructions to send a listing of the travel parking spots with the safety level score exceeding a threshold value of safety level and locations of the travel parking spots, respectively, within the geospatial area of the current location and the travel route of the vehicle.

9. The computer program product according to claim 8, wherein the online information sources include historical incident reports, government agency notifications, social media applications.

10. The computer program product according to claim 8, wherein program instructions for social media input includes formation of ad-hoc groups providing input of safety level experience at the travel parking spots from friends of and users known by the vehicle user.

11. The computer program product according to claim 8, further comprising:
program instructions to generate a field of view dashboard providing a visualization of a particular travel parking spot of the listing of the travel parking spots, based on sensor feeds of the static and dynamic IoT devices in a vicinity of the particular travel parking spot.

12. The computer program product according to claim 8, further comprising:
program instructions to detect the vehicle parking in a particular travel parking spot;
program instructions to tag automatically the particular travel parking spot with a date, time, and profile information of a vehicle user; and
program instructions to add information included in tagging of the particular travel parking spot in a blockchain data structure accessible online to trusted members of an ad-hoc group, wherein the vehicle user is determined to be trusted by a threshold of current ad-hoc group members.

13. The computer program product according to claim 8, wherein program instructions to input data to the geospatial spot security (GSS) model is weighted, such that feedback data of safety levels of travel parking spots are more heavily weighted for known users and friends of a user of the vehicle, and female gender friends and the known users are weighted more than male friends and the known users.

14. A computer system for determining a level of safety of a location for travel rest area parking of a vehicle, the computer system comprising:
one or more computer processors;
at least one computer readable storage devices; and
program instructions stored on the at least one computer readable storage devices for execution by the one or more computer processors, the stored program instructions comprising:
program instructions to determine a current location and a travel route of a vehicle;
program instructions to identify potential travel parking spots within a geospatial area of the current location and the travel route of the vehicle;
program instructions to receive data from online information sources and static and dynamic Internet of Things (IoT) devices in a vicinity of the travel parking spots within the geospatial area and the travel route of the vehicle;
program instructions to generate a safety level score for the travel parking spots in the geospatial area of the current location, based on an artificial intelligence (AI) model trained by IoT device data, and online data sources associated with travel parking area safety levels, and applying weighting to a type and a source of the IoT data and the online data; and
program instructions to send a listing of the travel parking spots with the safety level score exceeding a threshold value of safety level and locations of the travel parking spots, respectively, within the geospatial area of the current location and the travel route of the vehicle.

15. The computer system according to claim 14, wherein the online information sources include historical incident reports, government agency notifications, social media applications.

16. The computer system according to claim 14, wherein program instructions for social media input includes formation of ad-hoc groups providing input of safety level experience at the travel parking spots from friends of and users known by the vehicle user.

17. The computer system according to claim 14, wherein the IoT device data includes static and dynamic data, integrated with a vehicle sensor system and sensor data.

18. The computer system according to claim 14, further comprising:
program instructions to generate a field of view dashboard providing a visualization of a particular travel parking spot of the listing of the travel parking spots, based on sensor feeds of the static and dynamic IoT devices in a vicinity of the particular travel parking spot.

19. The computer system according to claim 14, further comprising:
program instructions to detect the vehicle parking in a particular travel parking spot;
program instructions to tag automatically the particular travel parking spot with a date, time, and profile information of a vehicle user; and
program instructions to add information included in tagging of the particular travel parking spot in a blockchain data structure accessible online to trusted members of an ad-hoc group, wherein the vehicle user is determined to be trusted by a threshold of current ad-hoc group members.

20. The computer system according to claim 14, wherein program instructions to input data to the geospatial spot security (GSS) model is weighted, such that feedback data of safety levels of travel parking spots are more heavily weighted for known users and friends of a user of the vehicle, and female gender friends and the known users are weighted more than male friends and the known users.
